(19) United States
(12) Patent Application Publication
(10) Pub. No.: US 2009/0255997 A1
(43) Pub. Date: Oct. 15, 2009

(54) Apparatus and Method for Flexibly and Efficiently Varying Air Temperatures in Multiple Rooms

(76) Inventors: Richard Goldmann, Poughkeepsie, NY (US); Russ Weinzimmer, Milford, NH (US); Douglas P. Burum, Acton, MA (US)

Correspondence Address: Russ Weinzimmer, 614 Nashua Street, Suite 53, Milford, NH, 03055, US

(21) Appl. No.: 12/101,994

(22) Filed: Apr. 13, 2008

(51) Int. Cl. G05D 23/30

(52) U.S. Cl. 236/1 B

(57) ABSTRACT

The invention enables coordinated, flexible, agile, and energy efficient temperature variation among a plurality of rooms, as found in a hotel, an apartment building, or a group of exercise rooms, by transferring heat between the rooms. Air can be moved by fans and/or heat can be transferred by a heat pump. Heat transfer between exercise rooms can be powered partly by exertion of individuals in the rooms. Rapid air exchange can quickly equalize temperatures in adjacent rooms. Embodiments exchange heat between rooms and interior and/or exterior reservoirs of warmer and cooler air and/or water, and some embodiments move air from the reservoirs into and out of the rooms. Heat can be pumped into or out of the system, and air and/or water can be added or extracted from the reservoirs. In some embodiments heat is moved sequentially through a variable series of rooms, creating a monotonic variation of temperatures.

### FIELD OF THE INVENTION

The invention generally relates to environmental control, and more specifically to temperature control in a plurality of rooms.

### BACKGROUND OF THE INVENTION

The control of temperatures inside of rooms and other indoor spaces is a well know art with a long history and many known types of apparatus and methods. However, the vast majority of temperature control systems are suitable mainly for achieving and maintaining a single, uniform temperature over long periods of time. In some cases, for example in a hotel or an apartment building, a plurality of interior spaces is divided into multiple temperature zones that are separately controlled, without any intentional interaction between the zones.

Under most circumstances, ideal air temperatures and ideal rates of heating and cooling do not vary significantly over short time periods, and so known solutions are found to be satisfactory. Circumstances do arise, however, where the heating and/or cooling requirements of different rooms or other zones differ significantly, change dramatically, and/or even reverse themselves over time. For example, a large building may be heated by the sun or cooled by a prevailing wind, causing one side of the building to be warmed or cooled more than the other. As the sun moves or the wind shifts, the cooling needs of the building can change dramatically, possibly even causing rooms that previously needed cooling to subsequently need warming while rooms that previously needed warming subsequently need cooling.

Another example of significant short-term changes in heating and cooling requirements is when individuals are undergoing vigorous exercise, since the ideal air temperature in an exercise environment can vary dramatically during the course of a workout. For example, a somewhat warmer temperature may be desired at the beginning of a workout, a much lower temperature may be desired at the peak of the workout, and a moderate temperature may be ideal during the final “cool down” phase of the workout. However, typical gyms or other exercise facilities only provide exercise rooms at a constant temperature, and consequently exercisers are too cold at the beginning of an exercise session, too warm at the end of an exercise session, and only briefly at the ideal temperature during the course of the exercise session.

However, because known systems for heating and cooling typically apply uncoordinated warming and cooling to multiple rooms and assume that optimal room temperatures do not change over short times, they operate with poor energy efficiency and at a high cost under these circumstances, and do not provide a high degree of temperature control flexibility.

### SUMMARY OF THE INVENTION

The invention enables coordinated, flexible, agile, and energy efficient temperature variation of a plurality of rooms or other spaces. For example, the invention enables a gym or other exercise facility to vary the interior temperatures in a plurality of separate exercise rooms, so as to continually maximize the comfort of exercisers during workouts while at the same time allowing the exercisers to begin their workouts at different times, continue their workouts for different lengths of time, and/or satisfy their individual temperature preferences. The invention can provide this temperature control in a manner that is more efficient and/or more flexible and agile than conventional methods.

An apparatus is disclosed that includes a heat transfer mechanism that is able to exchange heat between the rooms. In preferred embodiments the heat transfer mechanism is able to move air and/or pump heat between the rooms. In some embodiments there can be a rapid exchange of air that quickly equalizes the temperature of adjacent rooms. There can also be an exchange of air and/or heat between rooms and ambient air and/or water outside of the rooms.

Preferred embodiments include reservoirs of warmer and cooler air and/or water, with the heat transfer mechanism moving air and/or water between the reservoirs and/or pumping heat between the reservoirs. In some embodiments the heat transfer mechanism moves air from the reservoirs into and out of the rooms.

In some preferred embodiments the heat transfer mechanism is able to remove excess heat from the plurality of rooms by pumping heat out of the system of rooms and/or by introducing air from a location where the air is cooler than the average temperature of the rooms. In other preferred embodiments the heat transfer mechanism is able to add additional heat into the plurality of rooms by pumping heat into the system of rooms and/or by introducing air from a location where the air is warmer than the average temperature of the rooms.

In preferred embodiments, energy used to power the heat transfer mechanism is derived at least partly from physical exertion of individuals in at least one of the plurality of rooms.

In certain preferred embodiments, the heat transfer mechanism is able to move heat sequentially through a series of rooms composed of at least some of the plurality of rooms, so as to create a monotonic variation of air temperatures through the series of rooms. In some of these embodiments the heat transfer mechanism includes an air cooler that is able to introduce cool air into the series of rooms so as to create a monotonic variation of successively warmer air temperatures through the series of rooms, with the first room in the series being maintained at a cool temperature and successive rooms in the series being maintained at successively warmer temperatures. In other of these embodiments the heat transfer mechanism includes an air heater that is able to introduce warm air into the series of rooms so as to create a monotonic variation of successively cooler air temperatures through the series of rooms, with the first room in the series being maintained at a warm temperature and successive rooms in the series being maintained at successively cooler temperatures. And in some of these embodiments the heat transfer mechanism is able to modify at least one of the selection of rooms in the series of rooms and/or the ordering of rooms in the series of rooms.

### BRIEF DESCRIPTION OF THE DRAWINGS

FIG. 1A is a functional diagram illustrating a preferred embodiment of the present invention that uses a heater and an air conditioner;

FIG. 1B is a functional diagram illustrating an exchange of heat between two rooms in the preferred embodiment of FIG. 1A;

FIG. 1C is a simplified version of FIG. 1B showing only the interaction between the two rooms that are exchanging heat;

FIG. 1D is a functional diagram of the embodiment of FIG. 1A, substituting a heat pump for the heater and air conditioner;

FIG. 1E is a functional diagram illustrating the embodiment of FIG. 1D with two rooms sharing a set of connections to the warm air and cool air reservoirs;

FIG. 2A is a functional diagram illustrating the operating principles of a typical prior art air conditioner;

FIG. 2B is a functional diagram illustrating the operating principles of a heat pump that transfers heat between two circulating liquid reservoirs;

FIG. 2C is a functional diagram of the embodiment of FIG. 2B with additional heat exchangers that can be used to add or remove heat from the system, and with additional pipes and valves that can be used to add water to or remove water from the system;

FIG. 2D is a functional diagram illustrating the operating principles of a preferred embodiment that uses a heat pump to transfer heat between two circulating air reservoirs, and allows air to be added to and removed from the system;

FIG. 2E shows the functional diagram of FIG. 2D in a configuration where ambient air is being added to the cold reservoir so as to add heat to the system;

FIG. 2F shows the functional diagram of FIG. 2D in a configuration where ambient air is being added to the warm reservoir so as to remove heat from the system;

FIG. 3A is a simplified functional diagram illustrating the use of a heat pump such as the heat pump shown in FIG. 2D to heat one room while cooling another room;

FIG. 3B is a simplified functional diagram identical to the diagram of FIG. 3A with the direction of heat flow reversed;

FIG. 4A is a simplified functional diagram illustrating the use of fans to move air between a room and two air reservoirs;

FIG. 4B is a simplified functional diagram illustrating the use of fans and a heat exchanger to add heat to or remove heat from a room without an exchange of air;

FIG. 5 is the functional diagram of FIG. 1D with the addition of vents and connections that allow exchange of air directly between adjacent rooms and allow exchange of air directly between each room and its surrounding environment;

FIG. 6 illustrates the interior of a room from the embodiment of FIG. 5 that includes a large opening that enables exchange of air with an adjacent room and fans that enable exchange of air with the surrounding environment;

FIG. 7A is a plot of temperature versus time illustrating an exchange of temperatures between two rooms by exchanging and pumping heat between the rooms;

FIG. 7B is a plot of temperature versus time illustrating simultaneous heating of one room and cooling of another room by exchanging and pumping heat between the rooms and by exchanging heat between one of the rooms and the outside ambient environment;

FIG. 7C is a plot of temperature versus time illustrating simultaneous cooling of one room and heating of another room by venting the rooms to each other and by venting one of the rooms to the exterior ambient environment;

FIG. 7D is a plot of temperature versus time illustrating an exchange of temperatures between two rooms by exchanging heat between the rooms and by venting one room to the interior ambient environment and the other room to the exterior ambient environment;

FIG. 8A is a functional diagram illustrating the operation of a room temperature controller of a preferred embodiment;

FIG. 8B is a functional diagram illustrating the operation of a warm and cold reservoir controller of a preferred embodiment;

FIG. 9A is a simplified functional diagram of a preferred embodiment in which air is moved successively through a series of rooms so as to create a monotonic variation of temperatures in the series of rooms;

FIG. 9B is a functional diagram that extends the preferred embodiment of FIG. 9A to allow for arbitrary selection of the start and end of the series of rooms; and

FIG. 9C is a functional diagram of the embodiment of FIG. 9A with valves configured so as to move air successively through a specific series of rooms.

### DETAILED DESCRIPTION OF PREFERRED EMBODIMENTS

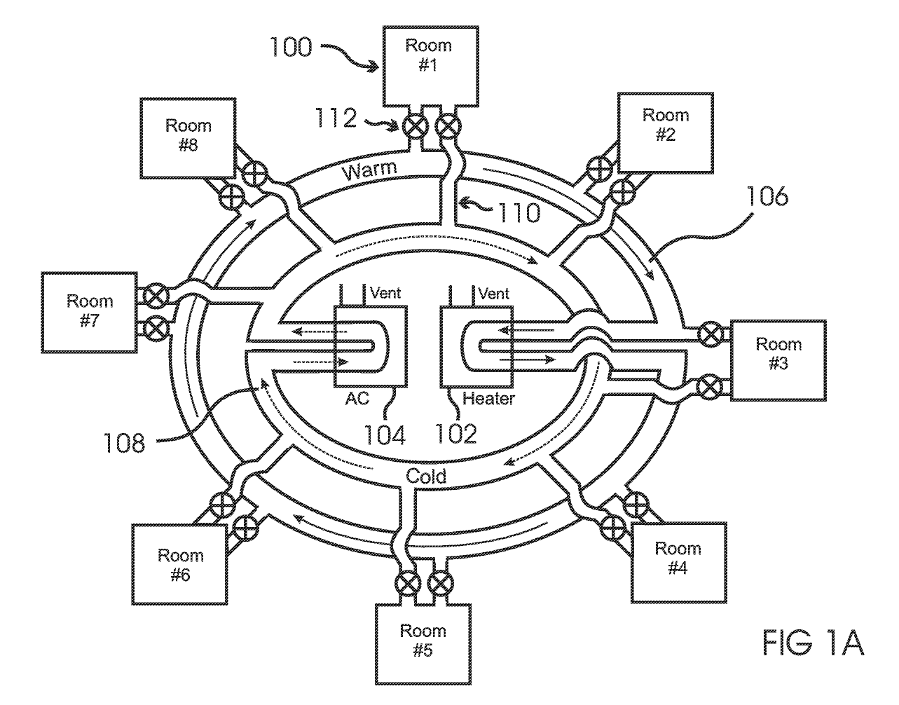

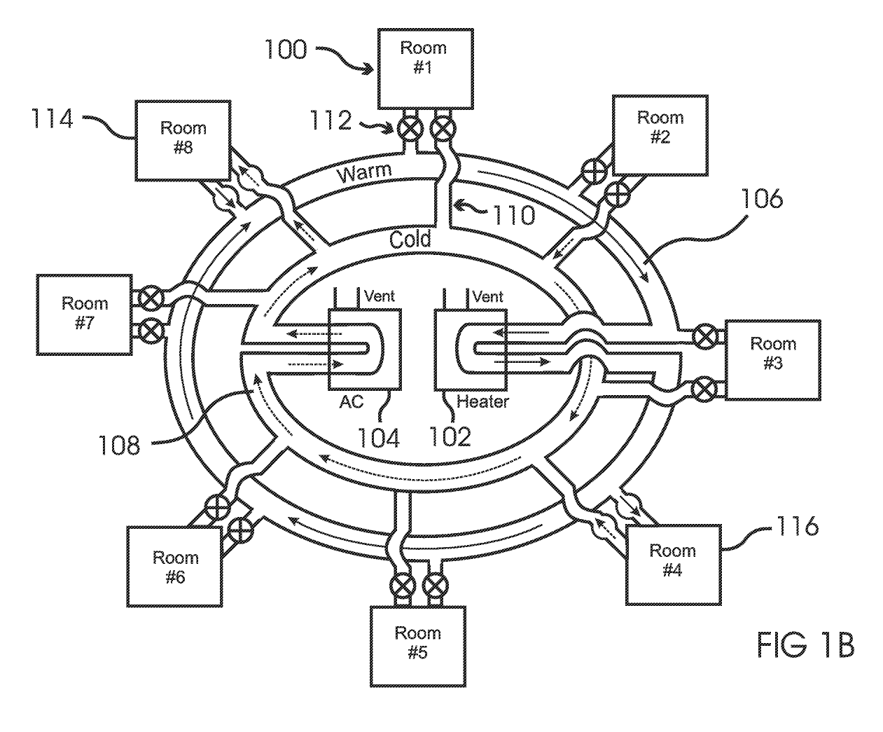

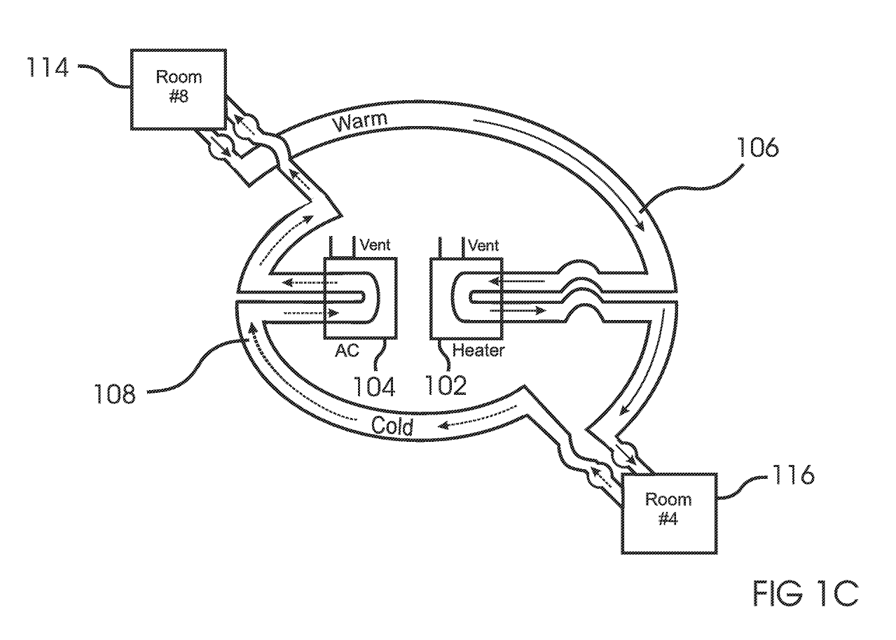

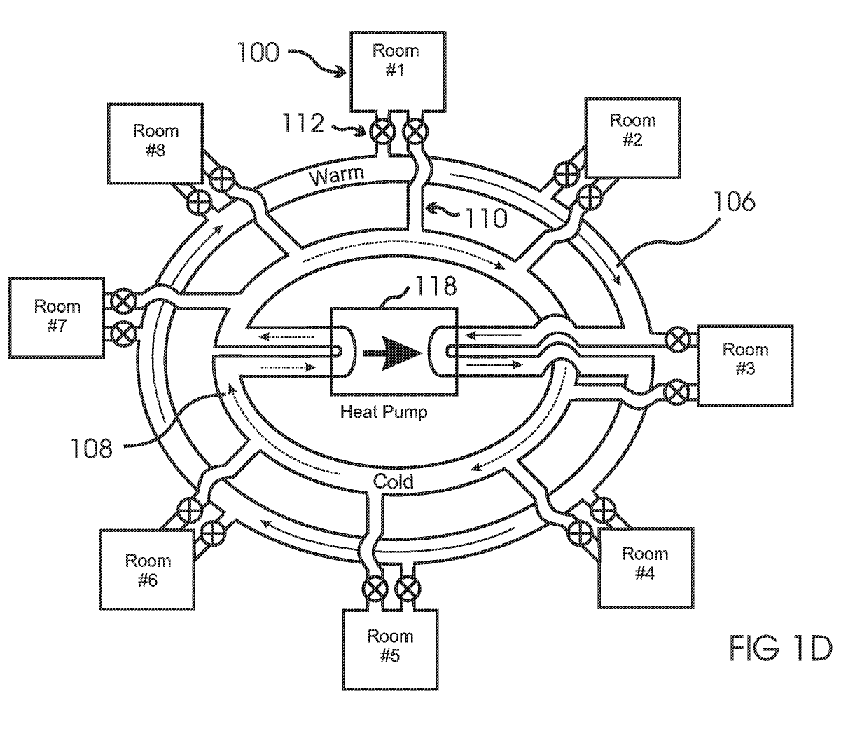

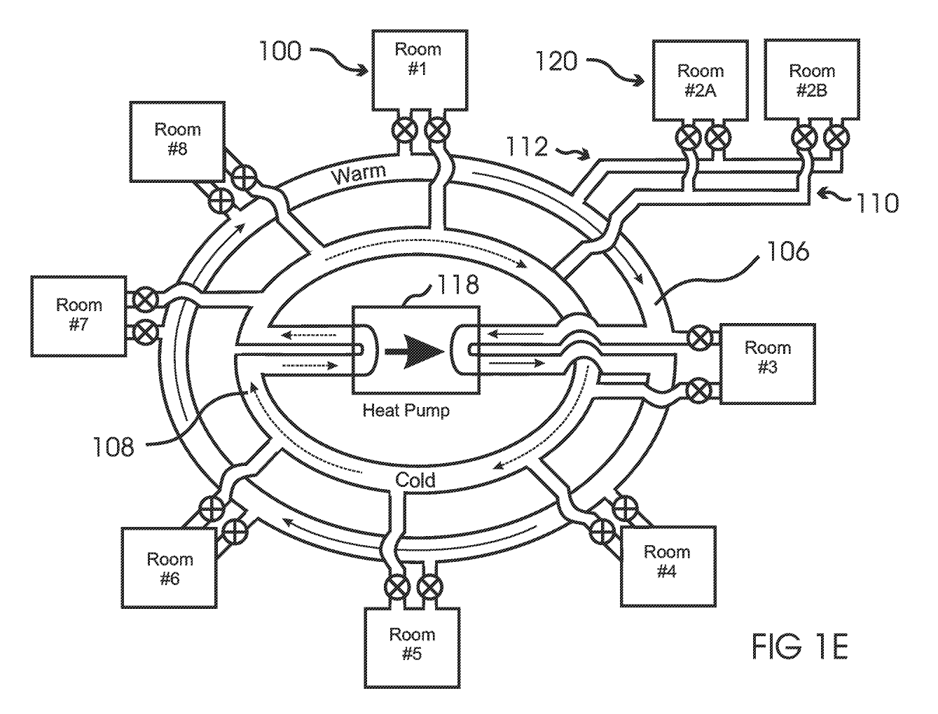

With reference to FIG. 1A, in a preferred embodiment a plurality of rooms 100 is heated by a heater 102 and cooled by an air conditioner. The heater 102 maintains a warm air reservoir 106, the air conditioner 104 maintains a cool air reservoir 108, and connections are provided between the rooms 100 and the reservoirs 106, 108 through ducts 110, 112. A room 100 is cooled or heated by simultaneously drawing air from one of the reservoirs while discharging air into the other reservoir. This allows for energy efficiency when rooms change temperature in at least a partly symmetric manner, as is discussed in more detail below, because the rooms can effectively exchange heat and/or air with each other.

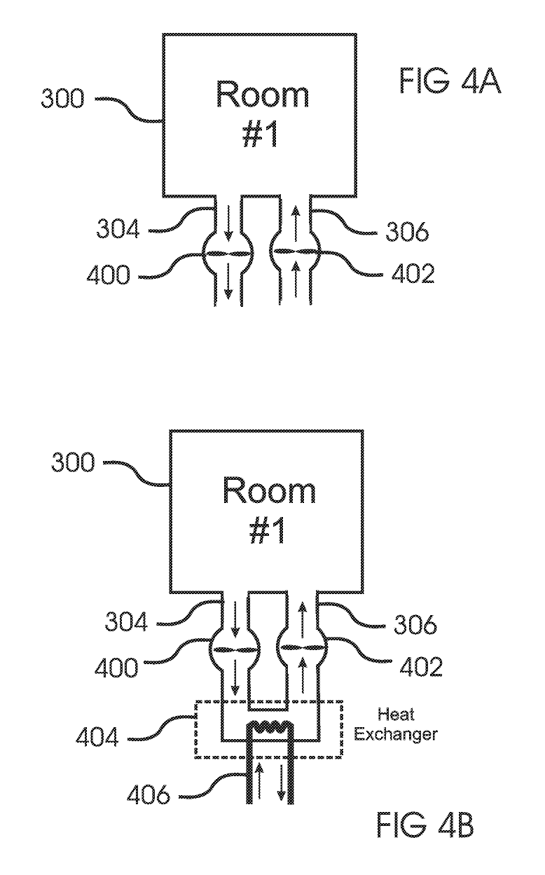

The air in the warm air reservoir 106 is constantly circulated through the heater 102, and the air in the cool air reservoir 108 is constantly circulated through the air conditioner 104, thereby maintaining the desired temperatures of the two reservoirs 106, 108 as air is withdrawn from them and discharged into them by the rooms. In the embodiment of FIG. 1A, air is directly exchanged between the rooms 100 and the reservoirs 106, 108, but in similar embodiments heat is exchanged without exchange of air, as illustrated in FIG. 4B (discussed further below). It should be noted that FIG. 1A is a functional diagram, and does not necessarily describe the physical arrangement of the elements. For example, the rooms 100 are not necessarily arranged in a circular configuration, the ducts 106, 108, are not necessarily curved, there can be more than one warm air 106 and/or cool air 108 circulation path, and the heater 102 and air conditioner 104 are not necessarily proximal to each other.

Exchange of heat between two specific rooms 114, 116 in this embodiment is illustrated in FIG. 1B. Air from the warm air reservoir 106 is blown by a fan (not shown) into the first room 114, and the displaced air from the first room is blown by another fan (not shown) into the cool air reservoir 108. At the same time, air from the cool air reservoir 108 is blown into the second room 116 and displaced air from the second room 116 is blown into the warm air reservoir 106. If the temperatures of the two rooms 114, 116 are to be brought closer to each other, then little or no action is required by the heater 102 or the air conditioner 104. On the other hand, if the temperatures of the two rooms 114, 116 are to be moved further apart, the heater 102 adds heat to the warm air reservoir 106 and the air conditioner 104 cools the air in the cool air reservoir 108.

FIG. 1C presents a simplified illustration of the exchange of heat between the two rooms 114, 116. All of the other rooms and the sections of ducting not involved in the heat exchange have been removed from the figure for the sake of clarity.

FIG. 1D is a functional diagram of the embodiment of FIG. 1A, substituting a heat pump 118 for the heater 102 and air conditioner 104, wherein the heat pump 118 moves heat from the cool air reservoir 108 to the warm air reservoir 110. Preferred embodiments that use a heat pump 118 offer a more energy efficient solution in many circumstances, since heat otherwise wasted by an air conditioner 104 is captured and used to supplement heat supplied by the heater 102.

Referring to FIG. 1E, under some circumstances the physical locations of rooms do not allow all of the rooms to be connected directly to the warm air reservoir 106 and to the cool air reservoir 108, even if the reservoirs are split into multiple circulating branches. In these cases it can be necessary for connecting ducts 110, 112 to be shared by more than one room, as shown in FIG. 1E. As illustrated in the figure, the ducts 110, 112 can be used normally whenever the rooms 120 sharing the ducts 110, 112 are either both being warmed or both being cooled. When one of the rooms 120 is being warmed and the other is being cooled, then the warming and cooling can be alternated so as to avoid air expelled from one of the rooms 120 being unintentionally drawn into the other room.

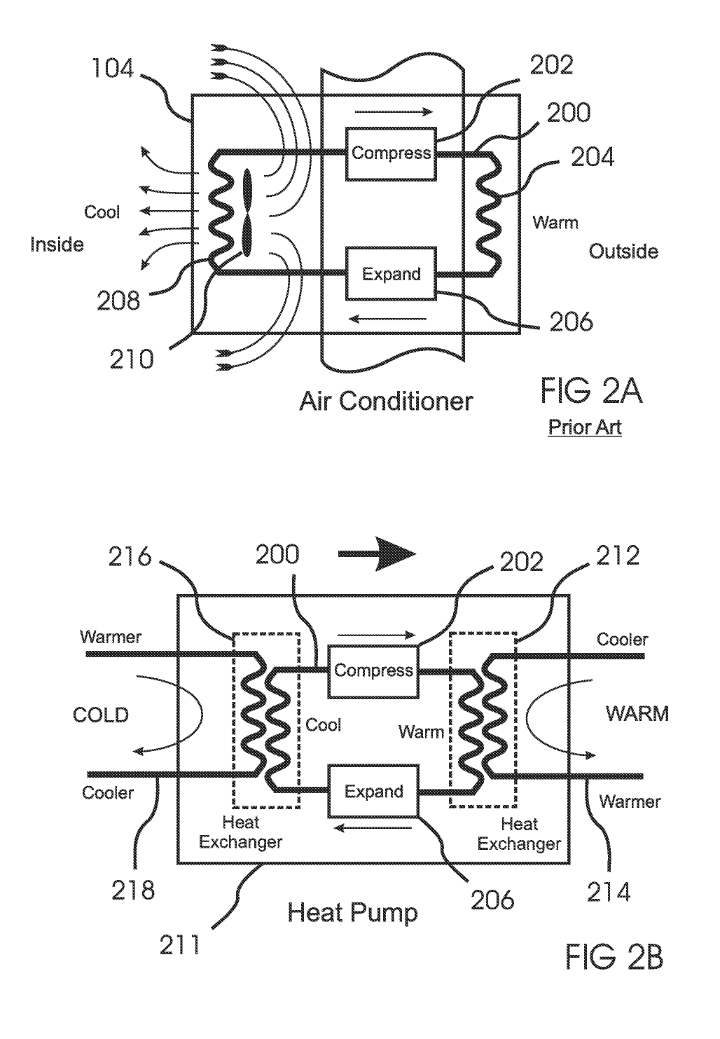

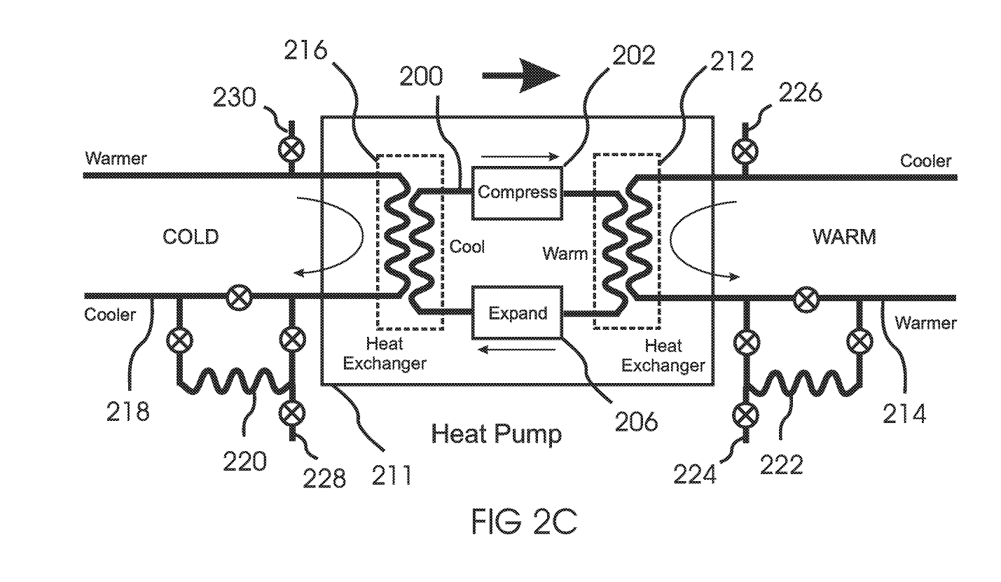

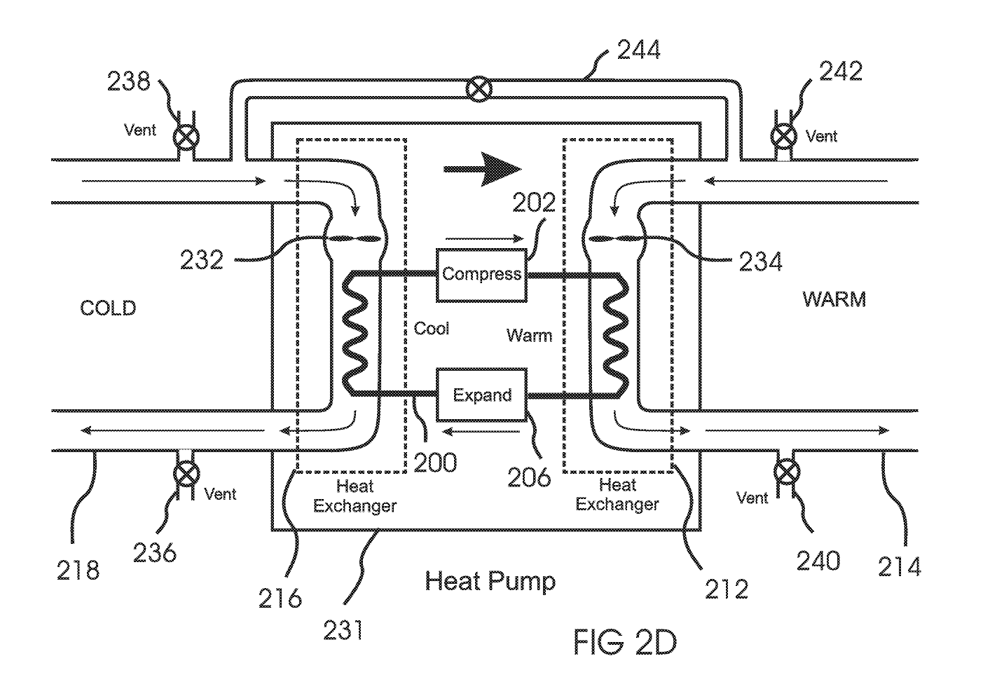

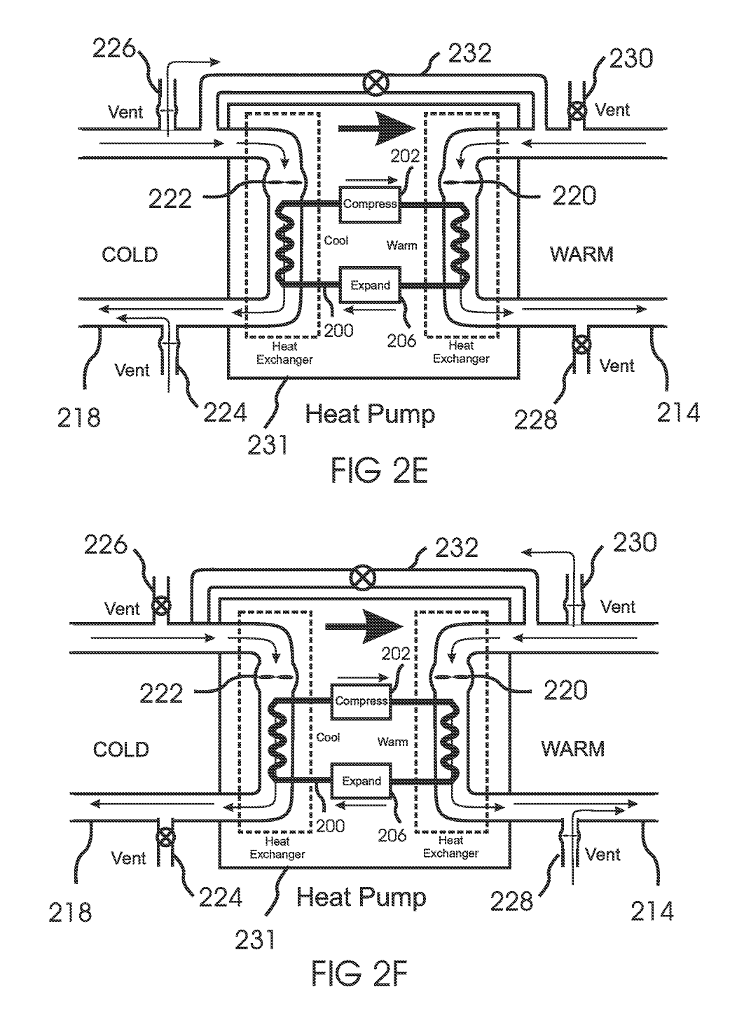

FIG. 2A is a functional diagram that illustrates the operation of a typical air conditioner 104 of the prior art. A refrigerating gas such as Freon is circulated through a pipe 200 in a closed loop. A condenser 202 compresses the gas and thereby heats it, after which the gas flows through a heat dissipater 204 located outside of the room, where it releases heat and cools to the ambient outside temperature. In a conventional air conditioner 104, the energy contained in this heat is wasted. Next, the gas is expanded 206, thereby cooling it to below the ambient outside temperature, and it is passed through a heat absorber 208. Air drawn either from outside the room or, as shown in FIG. 2A, re-circulated from inside the room is blown by a fan 210 across the heat absorber 208, thereby cooling the air inside of the room.

An air conditioner is an adaptation of a more general apparatus known as a heat pump. The functioning of a typical heat pump 211 is illustrated in FIG. 2B, is similar to the air conditioner illustrated in FIG. 2A. A refrigerating gas such as Freon circulates through a pipe 200 in a closed loop. After passing through a compressor 202 and being heated, the gas passes through a heat exchanger 212, where it is brought into thermal contact with a separate warm liquid or warm gas reservoir 214 where it gives up its excess heat. The warm liquid or warm gas reservoir serves to store the energy produced by compressing the refrigerating gas, rather than wasting this energy as would be the case for an air conditioner 104. The refrigerating gas is then further cooled by expansion 206 and passes through a second heat exchanger 216 where it absorbs excess heat from a separate cool liquid or cool gas reservoir 218. In this manner, heat is “pumped” from the cool reservoir 218 to the warm reservoir 214 (from left to right in FIG. 2B), without an exchange of gas or liquid between the two reservoirs 214, 218.

FIG. 2C illustrates the heat pump 211 of FIG. 2B, with two additional heat exchangers 220, 222 for exchanging heat between the warm 214 and cool 218 reservoirs and one or more external environments, and with valves and pipes 224, 228 included for drawing water from and adding water to the warm 214 and cool 218 reservoirs. In some embodiments, the average temperature of the warm and cool reservoirs is regulated by transferring excess heat to, or drawing additional heat from, an external “heat sink” such as the outdoor ambient air, a lake or other body of water, or the ground. By exchanging heat with an external heat sink, heat can be added to the system and the average temperature of the system can thereby be raised by diverting water from the cool reservoir 218 through a heat exchanger 220 coupled to the heat sink. In a similar manner, excess heat can be removed from the system and the average temperature of the system can thereby be lowered by diverting water from the warm reservoir 214 through a heat exchanger 222 coupled to the heat sink.

In some embodiments, excess heat from the warm reservoir is used for warming a swimming pool, a Jacuzzi, hot water in a plumbing system, or for other useful heating purposes, thereby reducing the energy consumed by a conventional water heater. This can be done either through a heat exchanger 222 or by drawing warm water directly from the warm reservoir 214 through a pipe 224 provided for that purpose, and replacing the warm water with cooler water through another pipe 226 provided for that purpose. Similarly, cool water can be extracted from the cool reservoir 218 through a pipe 228 and replenished with warmer water through another pipe 230.

FIG. 2D illustrates a heat pump 231 that transfers heat between two air reservoirs 214, 218 by blowing air from the reservoirs 214, 218 through heat exchangers 212, 216 using fans 232, 234. Heat is added to the system by introducing fresh air into the cool air reservoir through a duct 236 located just after the cool air passes through the cool air heat exchanger 216, and by venting cool air through a duct 238 located just before the cool air passes through the cool air heat exchanger 216. Similarly, excess heat is removed from the system by introducing fresh air into the warm air reservoir 214 through a duct 240 located just after the warm air passes through the warm air heat exchanger 212, and by venting warm air through a duct 242 located just before the warm air passes through the warm air heat exchanger 212. Note that these methods of adding heat to and removing heat from the system also serve to ventilate the system with fresh air. A pressure equalizing duct 244 is included in this embodiment to allow for equalization of the pressures between the two air reservoirs 214, 218, should that become necessary.

FIG. 2E illustrates the flow of air in the embodiment of FIG. 2D when adding heat to the system, and FIG. 2F illustrates the flow of air in the embodiment of FIG. 2D when removing heat from the system.

In some preferred embodiments of the present invention, heat pumps such as those illustrated in FIG. 2B, FIG. 2C, FIG. 2D, FIG. 2E, and FIG. 2F are used in combination with heaters and/or air conditioners.

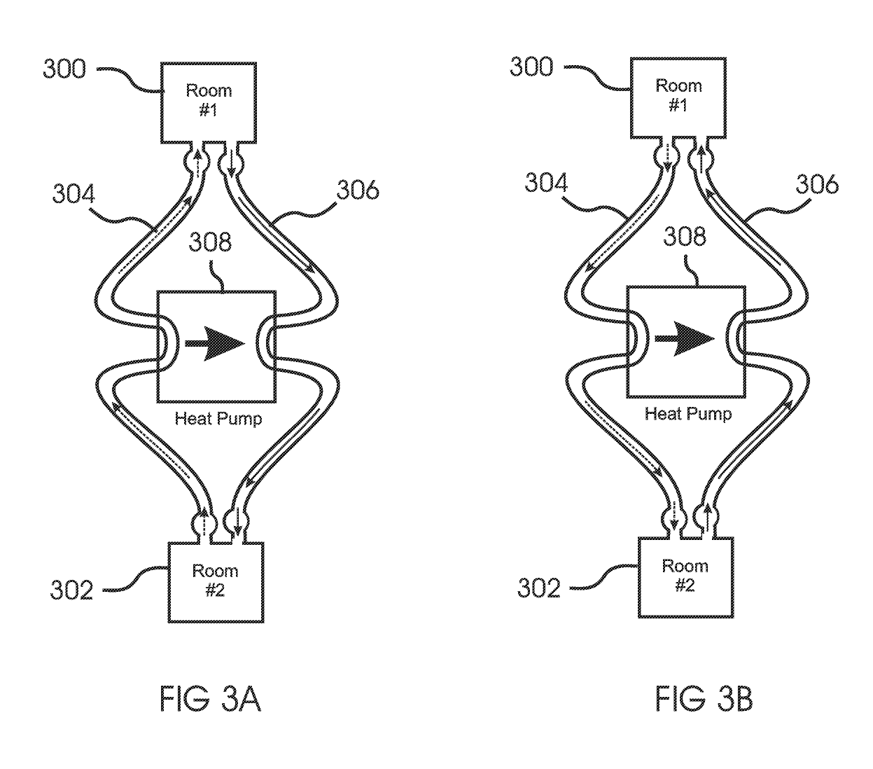

An example of using a heat pump to exchange heat between two rooms is illustrated in FIG. 3A and FIG. 3B. In these figures, the two rooms 300, 302 exchange heat through a flow of air that circulates through ducts 304, 306 that connect the two rooms 300, 302. One duct 304 passes through the cooling side of a heat pump 308, and the other duct 306 passes through the warming side of the heat pump 308. The direction of heat exchange is determined by the direction in which the air flows through the ducts 304, 306. In FIG. 3A, the first room 300 is cooled, while the second room 302 is warmed. In FIG. 3B, the direction of air flow is reversed, so that the first room 300 is warmed while the second room 302 is cooled.

FIG. 4A and FIG. 4B illustrate methods used in embodiments to move heat into and out of rooms. In FIG. 4A, air is directly exchanged between the room 300 and the warm and cool reservoirs by blowing the air through ducts 304, 306 using fans 400, 402. Direct exchange of air between rooms and reservoirs is a simple and efficient method of heat exchange, but may not be desirable in all cases. For example, in an apartment building direct exchange of air could lead to exchange of second hand smoke, cooking smells, pet dander and other allergens, etc. FIG. 4B illustrates an embodiment where heat is exchanged between rooms and warm and cool reservoirs without an exchange of air. In this embodiment, air is blown by fans 400, 402 past a heat exchanger 404, thereby bringing the air into thermal contact with a heat transferring fluid such as oil, Freon, water, or a mixture of water and ethylene glycol (i.e. anti-freeze) contained in a pipe 406. Heat is transferred between the room 300 and the heat transferring fluid without any exchange of air with the room 300.

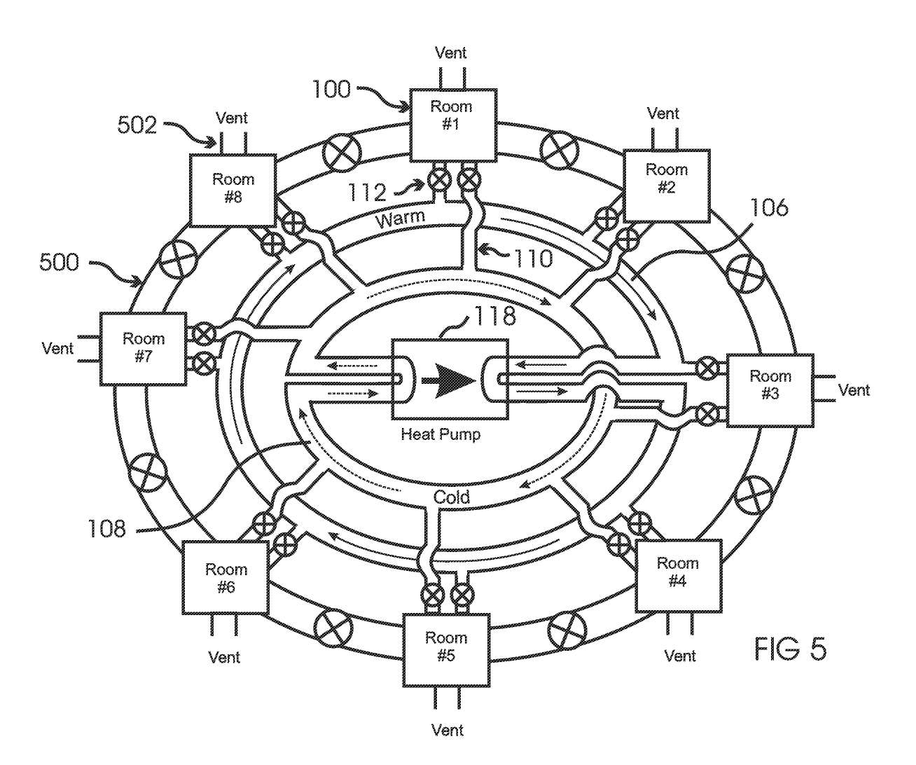

The preferred embodiment of FIG. 5 includes all of the features of the embodiment of FIG. 1A, and in addition includes direct connections 500 for air exchange between adjacent rooms, as well as vents 502 from each room to its surrounding environment. The direct connections 500 allow for a rapid of exchange of air and a consequent equalization of temperatures between adjacent rooms 100. This can be an efficient strategy if adjacent rooms 100 need to simultaneously change their temperatures. For example, if adjacent rooms 100 are at 60 degrees and 80 degrees, and the rooms 100 need to exchange temperatures with each other, then the connection between them 500 can be used to bring both of the rooms 100 to 70 degrees (assuming the rooms 100 have the same volumes), and then the connection 500 can be closed and the heat pump 118 and ducts 110, 112 can be used to complete the process. If two rooms 100 that are not adjacent are at 60 degrees and 80 degrees and need to exchange their temperatures, and if their surrounding environments of the two rooms 100 are at 70 degrees, the vents 502 from the two rooms 100 to their surrounding environments can be opened to bring both of the rooms 100 to a temperature of 70 degrees, and then the vents 502 can be closed and the heat pump 118 and ducts 110, 112 can complete the process.

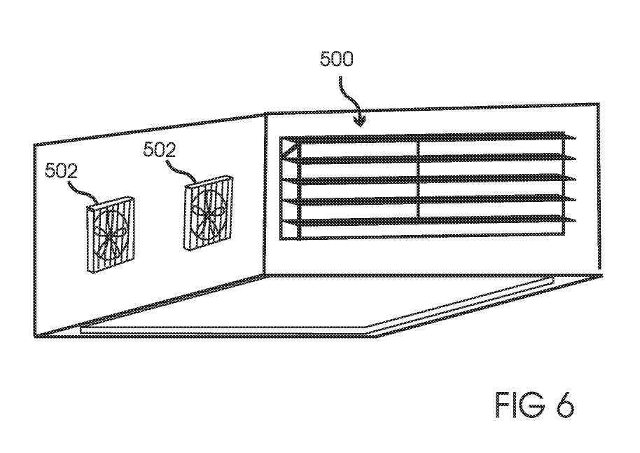

The interior of a room from the embodiment of FIG. 5 is shown in FIG. 6. A large shuttered opening 500 between the room and an adjacent room allows rapid mixing of air between the rooms when the shutters are opened. Two large ventilation ducts with fans 502 provide for rapid exchange of air with the surrounding environment.

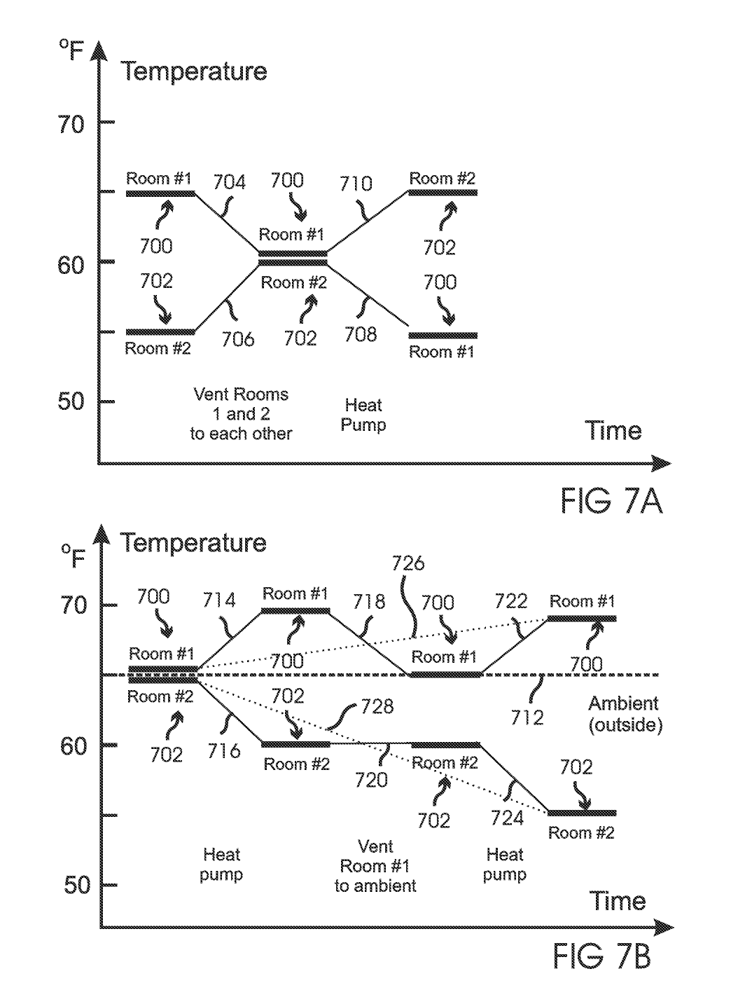

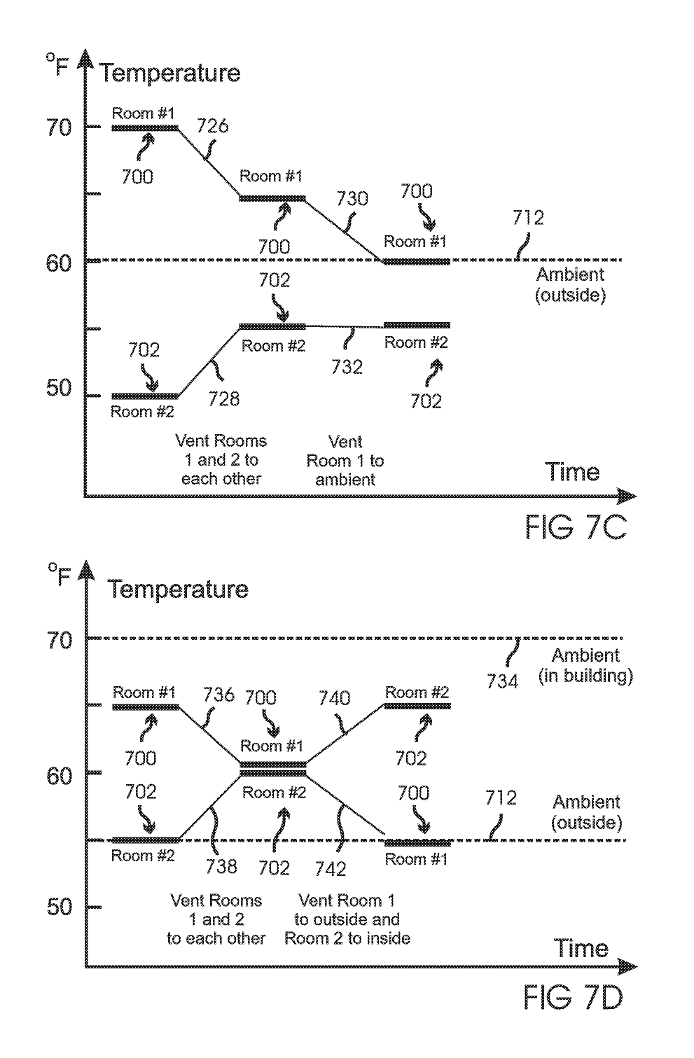

FIG. 7A is a diagram that illustrates how the elements of the embodiment of FIG. 5 can operate to cause an exchange of temperatures between two rooms 700, 702. In the diagram, one room 700 begins at 65 degrees Fahrenheit, and the other room begins at 55 degrees Fahrenheit. A vent 500 connecting the two rooms to each other is opened, causing the temperature of the first room 700 to drop 704, and the temperature of the second room 702 to rise 706, until the temperatures of the two rooms are equalized at 60 degrees Fahrenheit. At that point, the vent 500 connecting the two rooms is closed, and the first room 700 exchanges air with the cool air reservoir 106 while the second room 702 exchanges air with the warm air reservoir 108. The temperature difference between the cool air reservoir and the warm air reservoir is maintained by the heat pump 118, so that the heat pump 118 effectively is used to pump heat from the first room 700 to the second room 702. The process continues until the desired temperatures of 55 degrees for the first room 708 and 65 degrees for the second 710 room are achieved.

FIG. 7B is a diagram that illustrates how the elements of the embodiment of FIG. 5 can operate to change the temperatures of two rooms 700, 702 that are both initially at the same temperature, so as to create a temperature difference between the two rooms 700, 702 and also so as to shift their average temperature. Initially, the two rooms are both at the outside ambient temperature 712 of 65 degrees. The heat pump 118 is used to increase the temperature 714 of the first room 700 while decreasing the temperature 716 of the second room 700, in the same manner as was described with regard to the second half of FIG. 7A. The first room 700 is then vented 718 to the outside, returning it to 65 degrees and also freshening the air in the first room 700, while the second room 702 remains 720 at 60 degrees. Finally, the heat pump 118 is used to increase the temperature 722 of the first room 700 while decreasing the temperature 724 of the second room 702, thereby achieving the desired temperatures of 70 degrees for the first room 700 and 55 degrees for the second room 702. In FIG. 7B the temperature control operations are shown as being separated into discrete steps, so as to make them more easily understood. However, it will be clear to one of average skill in the art that the steps illustrated in the diagram can be applied in an overlapping manner, so as to cause the temperatures of the two rooms 700, 702 to transition smoothly 726, 728 from their beginning temperatures to their ending temperatures.

FIG. 7C is a diagram that illustrates how the vents 500 of the embodiment of FIG. 5 can operate to cause the temperatures of two rooms 700, 702 to be brought closer to each other without use of the heat pump 118, while also shifting the average temperature of the rooms. In FIG. 7C, the first room 700 is initially at 70 degrees while the second room 702 is initially at 50 degrees. The vent 500 between the two rooms is opened until the temperature of the first room 700 has dropped to 65 degrees 726 and the temperature of the second room 702 has risen 728 to 55 degrees. The vent 500 between the two rooms is then closed, and a vent 502 is opened between the first room and the outside ambient air 712, thereby lowering the temperature 730 of the first room 700 to the ambient temperature while freshening the air in the first room 700. The air in the second room 702 remains at 55 degrees 732, thereby achieving the desired final temperatures for the two rooms of 60 degrees and 55 degrees.

FIG. 7D is a diagram that illustrates how the elements of the embodiment of FIG. 5 can operate to cause an exchange of temperatures between two rooms 700, 702 without use of the heat pump 118 by interacting with two different heat reservoirs 712, 734. The two reservoirs 712, 734 are indicated in the diagram as ambient outside air 712 and ambient air inside of a building 734. However, it will be clear to one of average skill in the art that other reservoirs can be substituted and/or added, such as water in a swimming pool, water in a nearby lake, water in a well, or water circulated through pipes buried in the ground. In the figure, the first room 700 begins at 65 degrees and the second room 702 begins at 55 degrees. A vent 500 between the two rooms is opened, allowing the temperature of the first room 700 to drop 736 and the temperature of the second room 702 to rise 738 until both rooms are at 60 degrees. The vent 500 between the rooms is then closed, and vents connecting the second room 702 to warm ambient indoor air 734 and connecting the first room 700 to cool ambient outdoor air 712 are opened. This causes the air inside both of the rooms to be freshened, while the temperature of second room rises 740 to 65 degrees and the temperature of the first room falls 742 to 55 degrees, thereby achieving the desired result.

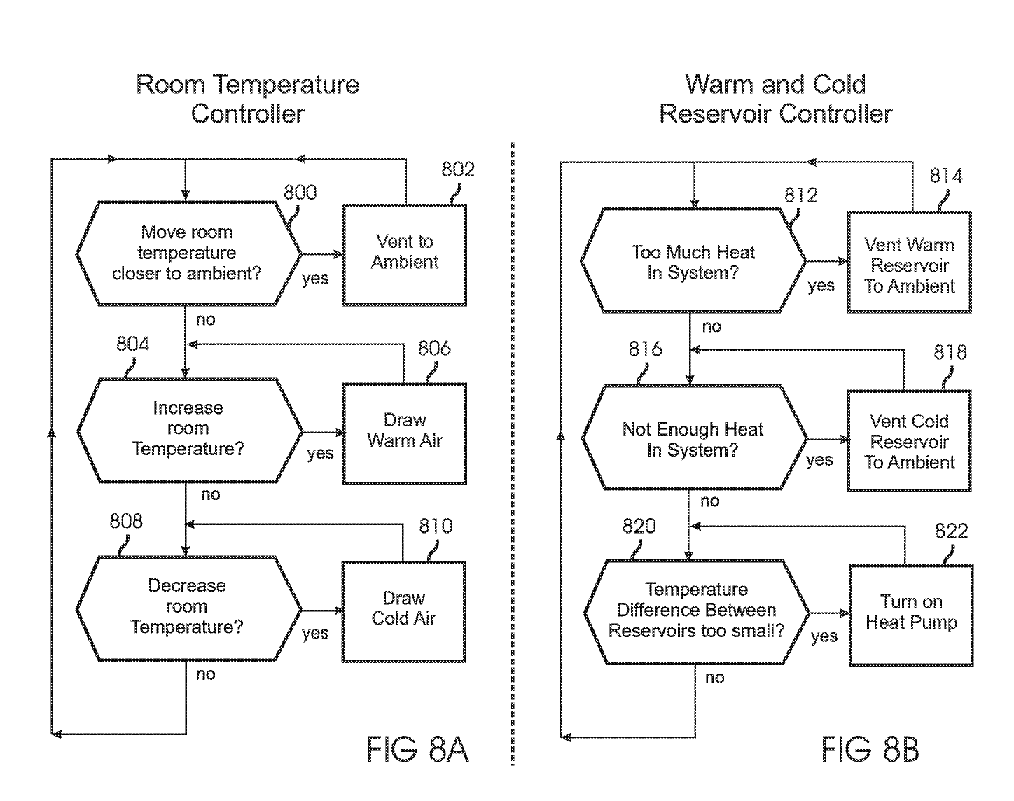

FIG. 8A is a functional diagram that illustrates the operation of a room temperature controller in the preferred embodiment of FIG. 5A. If it is desired to move the temperature of a room closer to the ambient temperature 800, the controller vents the room to the ambient air 802. Having done as much as possible with the ambient air vent, if it is desired to increase the temperature of the room 804 still further, the controller causes air to enter the room 806 from the warm air reservoir 106, and if it is desired to decrease the temperature of the room 808 the controller causes air to enter the room 810 from the cold air reservoir 108.

FIG. 8B is a functional diagram that illustrates the operation of a reservoir temperature controller that maintains the desired temperatures of the warm air reservoir 106 and the cold air reservoir 108. If the average temperature of the two reservoirs is too warm 812, the warm air reservoir is vented to the ambient surroundings 814. If the average temperature of the two reservoirs is too cool 816, the cool air reservoir is vented to the ambient surrounding 818. If the temperature difference between the warm air reservoir 106 and the cool air reservoir 108 is too small 820, the heat pump 118 is used 822 to increase the temperature difference between the two reservoirs 106, 108.

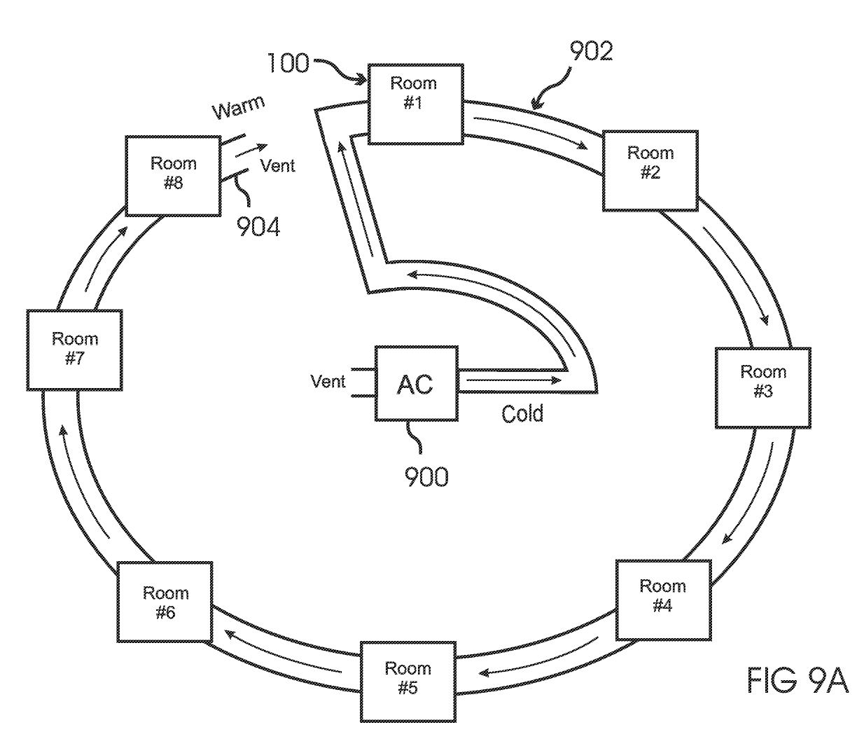

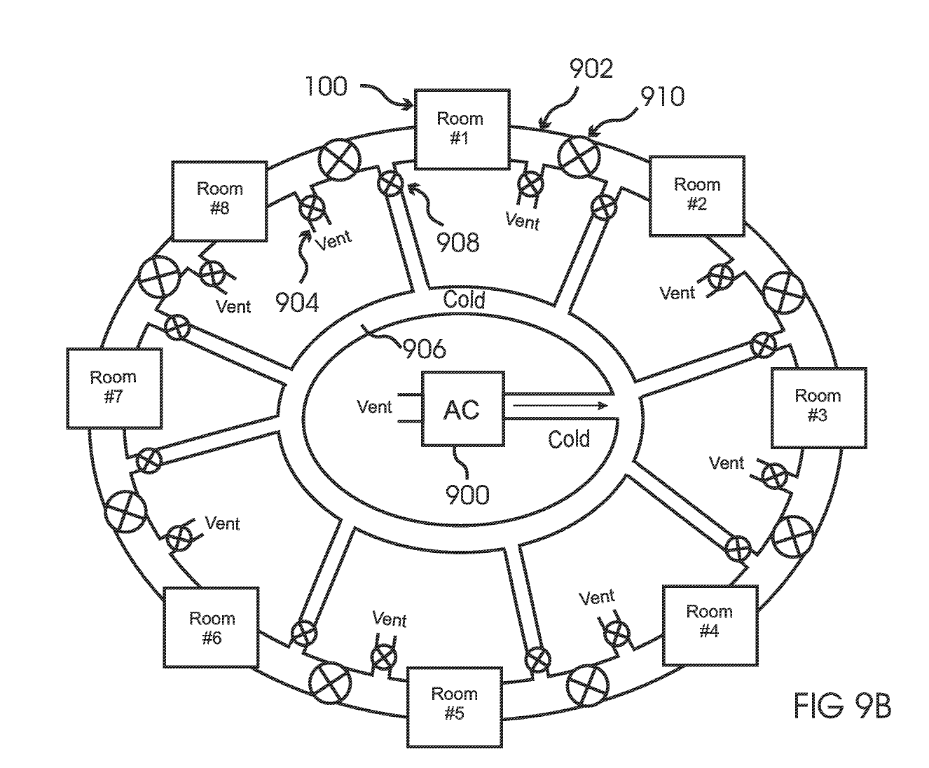

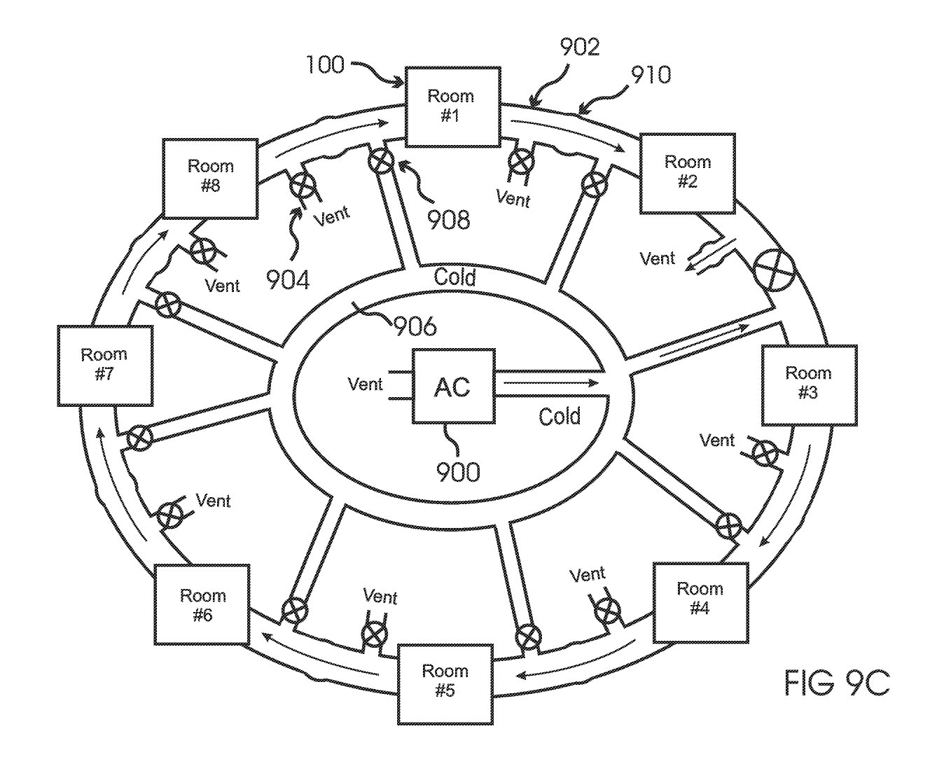

FIG. 9A illustrates an embodiment of the invention that is able to establish and maintain a monotonically varying temperature with high energy efficiency across a series of connected rooms 100. This embodiment can be applied, for example, at a gym where it is desirable to provide different air temperatures during different stages of an exercise workout. By establishing progressively cooler temperatures in a series of rooms 100, this embodiment of the invention can allow exercisers to experience cooler temperatures as their workout progresses, or in general to experience any desired temperature at any time during a workout, simply by moving from one room to another. Or, by periodically changing the air inlet and outlet locations within the series of rooms 100, rooms can be caused to change in temperature and thereby to accommodate the preferences of exercisers without the need for exercisers to change rooms.

The embodiment provides cool air from a conventional air conditioner 900 to the first in a series of rooms 100. The rooms 100 are connected in series by ducts 902 that allow air from the air conditioner 100 to flow through the entire series of rooms 100 and to exit from a vent 904 after passing through the last room in the series 100. Since the air will be warmed by heat leaking into the rooms and by heat from occupants, lights, and such like in the rooms, the temperatures in the series of rooms 100 will be progressively warmer. The relative temperatures in the series of rooms 100 can be adjusted by controlling the rate of airflow between each pair of adjoining rooms.

FIG. 9B illustrates how the concept illustrated in FIG. 9A can be generalized to allow the beginning and end of the series to be arbitrarily selected. In this embodiment, the air conditioner 900 is connected by a set of supply ducts 906 and valves 908 to the ducts 902 that connect between the rooms 100. The ducts that connect between the rooms 902 further include interconnecting valves 910 and exhaust vents 904 with shut-off valves.

FIG. 9C illustrates the embodiment of FIG. 9B with a specific configuration of opened and closed valves that provides a flow of air beginning at room #3 and ending at room #2. Other valve configurations allow different start and end rooms, including sub-series of rooms that do not include the entire plurality of rooms 100. In similar embodiments where, for example, the ambient temperature surrounding the rooms is very cold, a heater is used in place of the air conditioner 900 so that the first room in the series 100 is warmed by the heater and successive rooms in the series 100 are monotonically cooler than the first room.

Other modifications and implementations will occur to those skilled in the art without departing from the spirit and the scope of the invention as claimed. Accordingly, the above description is not intended to limit the invention except as indicated in the following claims.

What is claimed is:

1. An apparatus for separately and efficiently controlling the temperatures in a plurality of rooms, the apparatus comprising:
a temperature controller that is able to separately control the temperatures of the rooms;
a heat transfer mechanism controlled by the temperature controller that is able to flexibly control and change the temperatures in the rooms at least partly by causing a transfer of heat between the rooms; and
at least one of a mechanism for adding heat to the plurality of rooms and a mechanism for removing heat from the plurality of rooms.

2. The apparatus of claim 1, wherein the heat transfer mechanism is able to move air between the rooms.

3. The apparatus of claim 2, wherein the heat transfer mechanism is able to create a rapid exchange of air and a consequent rapid equalization of temperatures between adjacent rooms.

4. The apparatus of claim 1, wherein the heat transfer mechanism is able to pump heat between the rooms.

5. The apparatus of claim 1, wherein the heat transfer mechanism is able to increase the temperature of a room by moving heat from a warm reservoir into the room, and the heat transfer mechanism is able to reduce the temperature of a room by moving heat from the room into a cool reservoir.

6. The apparatus of claim 1, wherein the heat transfer mechanism is able to pump heat between a cool reservoir and a warm reservoir.

7. The apparatus of claim 1, wherein the heat transfer mechanism is able to move air from a reservoir of cooler air and air from a reservoir of warmer air into and out of the rooms.

8. The apparatus of claim 1, wherein the heat transfer mechanism is able to remove excess heat from the plurality of rooms by introducing air into the plurality of rooms from a location where the air is cooler than the average temperature of the air in the plurality of rooms.

9. The apparatus of claim 1, wherein the heat transfer mechanism is able to introduce additional heat into the plurality of rooms by introducing air into the plurality of rooms from a location where the air is warmer than the average temperature of the air in the plurality of rooms.

10. The apparatus of claim 1, wherein the heat transfer mechanism is able to remove excess heat from the plurality of rooms by exchanging heat between the plurality of rooms and an environment that is cooler than the average temperature of the air in the plurality of rooms.

11. The apparatus of claim 1, wherein the heat transfer mechanism is able to introduce additional heat into the plurality of rooms by exchanging heat between the plurality of rooms and an environment that is warmer than the average temperature of the air in the plurality of rooms.

12. The apparatus of claim 1, wherein the heat transfer mechanism is able to cause an exchange of heat between at least one of the rooms and the environment outside of the room.

13. The apparatus of claim 1, wherein the heat transfer mechanism is able to cause an exchange of air between at least one of the rooms and the environment outside of the room.

14. The apparatus of claim 1, wherein energy used to power the heat transfer mechanism is derived at least partly from physical exertion of individuals in at least one of the plurality of rooms.

15. The apparatus of claim 1, wherein the heat transfer mechanism is able to move heat sequentially through a series of rooms composed of at least some of the plurality of rooms, so as to create a monotonic variation of air temperatures through the series of rooms.

16. The apparatus of claim 15, wherein the heat transfer mechanism includes an air cooler that is able to introduce cool air into the series of rooms so as to create a monotonic variation of air temperatures through the series of rooms such that the first room in the series is maintained at a cool temperature and successive rooms in the series are maintained at successively warmer temperatures.

17. The apparatus of claim 15, wherein the heat transfer mechanism includes an air heater that is able to introduce warm air into the series of rooms so as to create a monotonic variation of air temperatures through the series of rooms such that the first room in the series is maintained at a warm temperature and successive rooms in the series are maintained at successively cooler temperatures.

18. The apparatus of claim 15, wherein the heat transfer mechanism is able to modify at least one of the selection of rooms in the series of rooms and the ordering of rooms in the series of rooms.

19. The apparatus of claim 1, wherein excess heat from the apparatus can be used to heat water for one of a swimming pool, a Jacuzzi, a sauna, a sink, a shower, a bath tub, a dishwasher, a washing machine, and other appliances that use hot water.
